(19) United States
(12) Patent Application Publication
(10) Pub. No.: US 2026/0162283 A1
(43) Pub. Date: Jun. 11, 2026

(54) DEPTH SENSING SYSTEM AND DEPTH SENSING METHOD THEREOF

(71) Applicant: HIMAX TECHNOLOGIES LIMITED, Tainan City (TW)

(72) Inventors: Hsueh-Tsung LU, Tainan City (TW); Wu-Feng CHEN, Tainan City (TW)

(21) Appl. No.: 18/973,129

(22) Filed: Dec. 9, 2024

(51) Int. Cl. G06T 7/50; G01B 11/22; H04N 23/67

(52) U.S. Cl. CPC G06T 7/50; G01B 11/22; H04N 23/675; G06T 2207/20084

(57) ABSTRACT

A depth sensing system and depth sensing method thereof are provided. The depth sensing system includes a light emitter, a sensor assembly, a driving circuit, and a depth decoding circuitry. The light emitter is configured to emit a light source to a target. The sensor assembly includes at least one optical lens and is configured to generate an image including the target. The driving circuit is configured to provide driving signals to adjust an optical characteristic of the at least one optical lens corresponding to a desired region of the target in the image for varying a size of the desired region of the target in the image. The depth decoding circuitry is electrically connected to the light emitter, the sensor assembly, and the driving circuit, and is configured to decode the image after varying the size of the desired region, and output depth information of the image.

### BACKGROUND

### Technical Field

The disclosure relates to a depth sensing system and a depth sensing method thereof, and more particularly to a depth sensing system having a function of enhancing the spatial resolution of a desired region in an image and a depth sensing method thereof.

### Description of Related Art

In depth sensing applications, depth sensors are not only capable of providing depth information for an entire scene, but are also used to provide the depth information for specific targets or specific regions. In the current applications, various computer vision algorithms or artificial intelligence neural network models are used for target detection for the captured images, which may accurately detect a region of interest (ROI) of the target in the image.

However, in practical applications, the target may be too far away from the sensor assembly, resulting in the target in the image being too small. In other word, the ROI of the target occupies too few pixels in the image and has a low spatial resolution. As a result, the details or information decoded from the image is not sufficient to meet the requirement of the applications.

### SUMMARY

An objective of the present disclosure is to provide a depth sensing system. The depth sensing system includes a light emitter, a sensor assembly, a driving circuit, and a depth decoding circuitry. The light emitter is configured to emit a light source to a target. The sensor assembly includes at least one optical lens and is configured to generate an image including the target. The driving circuit is configured to provide driving signals to adjust an optical characteristic of the at least one optical lens corresponding to a desired region of the target in the image for varying a size of the desired region of the target in the image. The depth decoding circuitry is electrically connected to the light emitter, the sensor assembly, and the driving circuit, and is configured to decode the image after varying the size of the desired region, and output depth information of the image.

Another objective of the present disclosure is to provide a depth sensing method. The depth sensing method is performed by a depth sensing system, in which the depth sensing system includes a sensor assembly including at least one optical lens. The depth sensing method includes obtaining an image comprising a target; selecting a desired region of the target in the image; providing one or more driving signals to adjust an optical characteristic of the at least one optical lens corresponding to the desired region for varying a size of the desired region of the target in the image; and decoding the image and outputting depth information of the image after varying the size of the desired region.

### BRIEF DESCRIPTION OF THE DRAWINGS

FIG. 1 is a schematic diagram showing a depth sensing system in accordance with an embodiment of the present disclosure.

FIG. 2 is a schematic diagram showing a detailed structure of the depth sensing system in accordance with an embodiment of the present disclosure.

FIG. 3 is a schematic diagram showing a depth sensing system in accordance with an embodiment of the present disclosure.

FIGS. 4A to 4I are schematic diagrams showing various configurations of the sensor assembly in accordance with some embodiments of the present disclosure.

FIG. 5 is a schematic diagram showing a depth sensing method in accordance with an embodiment of the present disclosure.

FIG. 6A is a schematic diagram showing an image including a target and a desired region thereof in accordance with an embodiment of the present disclosure.

FIG. 6B is a schematic diagram showing an image including a target and a desired region thereof after varying a size of the desired region of the target in accordance with an embodiment of the present disclosure.

### DETAILED DESCRIPTION

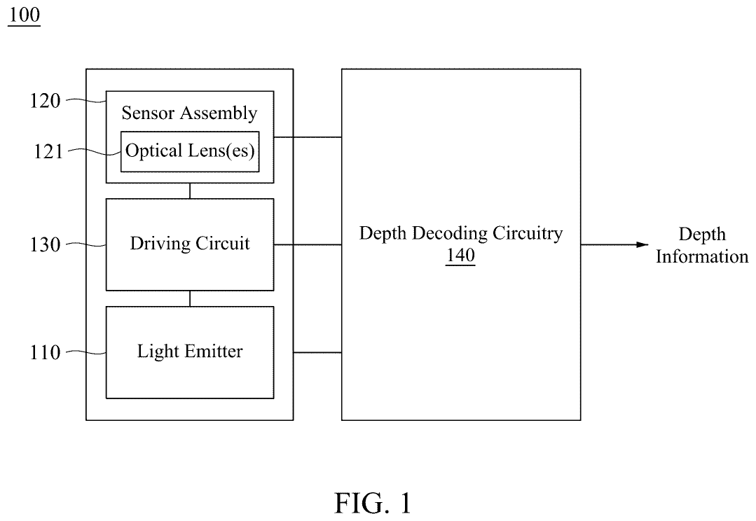

Referring to FIG. 1, FIG. 1 is a depth sensing system 100 in accordance with an embodiment of the present disclosure. The depth sensing system 100 includes a light emitter 110, a sensor assembly 120, a driving circuit 130, and a depth decoding circuitry 140.

The light emitter 110 is configured to emit a light source to a target, and the sensor assembly 120 generates an image including the target therein based on the light source reflected from the target. The light emitter 110 may be an infrared emitter, a laser emitter, a light emitting diode (LED) emitter, a structured light emitter, a visible light emitter, or the like. The sensor assembly 120 includes at least one optical lens 121 and other components such as a bandpass filter 122, a micro lens array 123, a sensor 124 and a lens set 125 (which are not shown in FIG. 1).

The optical characteristics of the optical lens 121, such as a curvature, a phase difference and an applied voltage distribution, may be adjusted to vary a size of a desired region of the target in the image. In the embodiment of the disclosure, the optical lens 121 may be a liquid crystal lens or a liquid lens.

The driving circuit 130 is electrically connected to the light emitter 110 and the sensor assembly 120, and is configured to provide driving signals to adjust the optical characteristic of the optical lens 121 corresponding to the desired region of the target in the image. As a result, the desired region of the target in the image can be enlarged or reduced to an appropriate size, increasing the number of pixels corresponding to the desired region of the target in the image and increasing the details and information available for decoding.

In some embodiments, the driving circuit 130 includes a receiver (Rx) driver and a transmitter (Tx) driver. The Rx driver is configured to drive the optical lens 121 of the sensor assembly 120 to vary the size of the desired region of the target in the image. The Tx driver is configured to drive the light emitter 110 to emit light sources of varying duration, frequency, or intensity.

The depth decoding circuitry 140 is electrically connected to the light emitter 110, the sensor assembly 120 and the driving circuit 130, and is configured to decode the image after varying the size of the desired region, and output depth information of the image.

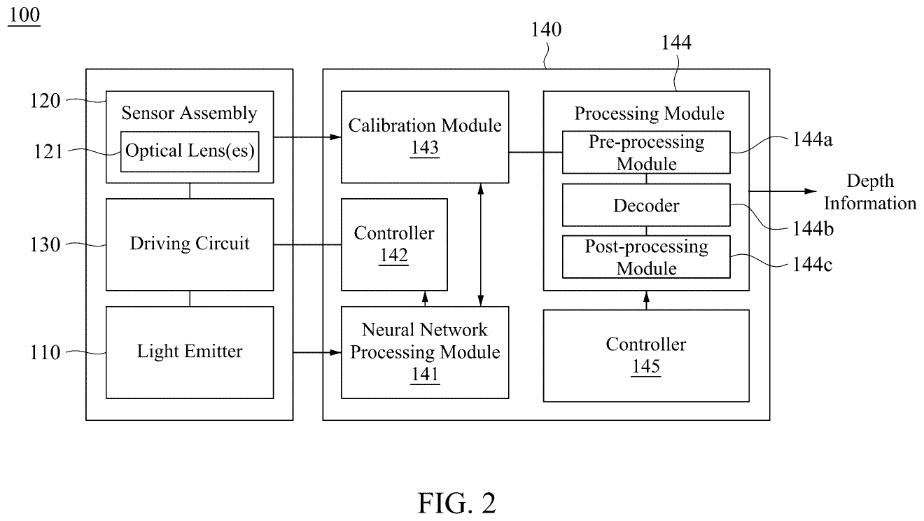

Referring to FIG. 2, FIG. 2 is a schematic diagram showing a detailed structure of the depth sensing system 100 in accordance with an embodiment of the present disclosure. The depth decoding circuitry 140 includes a neural network processing module 141, controllers 142 and 145, a calibration module 143, and a processing module 144.

The neural network processing module 141 is electrically connected to the sensor assembly 120, the calibration module 143, and the controllers 142 and 145, and is configured to detect the desired region of the target in the image. Specifically, after the sensor assembly 120 generates the image, the neural network processing module 141 may detect a region of interest (ROI), i.e., the desired region, of the image based on the needs of the application or the users. For example, the neural network processing module 141 may recognize and mark a face region on the image for further processing by other modules if the target is a person and the desired region is the face region of the person.

The controller 142 is electrically connected between the driving circuit 130 and the neural network processing module 141, and is configured to control the driving circuit 130 to provide one or more driving signal(s) corresponding to the desired region detected by the neural network processing module 141.

The calibration module 143 is configured to adjust an internal camera parameter, depth correction information, and distortion correction information corresponding to the desired region in response to the variation in the size of the desired region. Specifically, while the optical lens 121 of the sensor assembly 120 is used to change the size of the desired region, thereby increasing the number of pixels available for analyzing the depth information, which also results in image distortion such as contour or shape deformation. Therefore, after varying the size of the desired region, it is necessary to dynamically adjust the distortion correction information, the depth correction information, and the internal camera parameters corresponding to the desired region so that the depth decoding circuitry 140 can ultimately output the correct depth information.

The processing module 144 is configured to decode the image based on the internal camera parameter, the depth correction information, and the distortion correction information corresponding to the desired region, thereby outputting the depth information of the image. In the embodiment of the disclosure, the processing module 144 further includes a pre-processing module 144a, a decoder 144b, and a post-processing module 144c. In the embodiment of the disclosure, the controller 145 is electrically connected between the neural network processing module 141 and the processing module 144 for controlling the pre-processing module 144a, the decoder 144b, and the post-processing module 144c.

The pre-processing module 144a is configured to perform processes such as noise reduction, data normalization, and filtering to improve the quality and reliability of the image before decoding the image by the decoder 144b. The post-processing module 144c is configured to perform processes such as smoothing, filling in missing data, filtering on the image to produce resulting high quality depth information that may be used for 3D modeling, object detection, or the like.

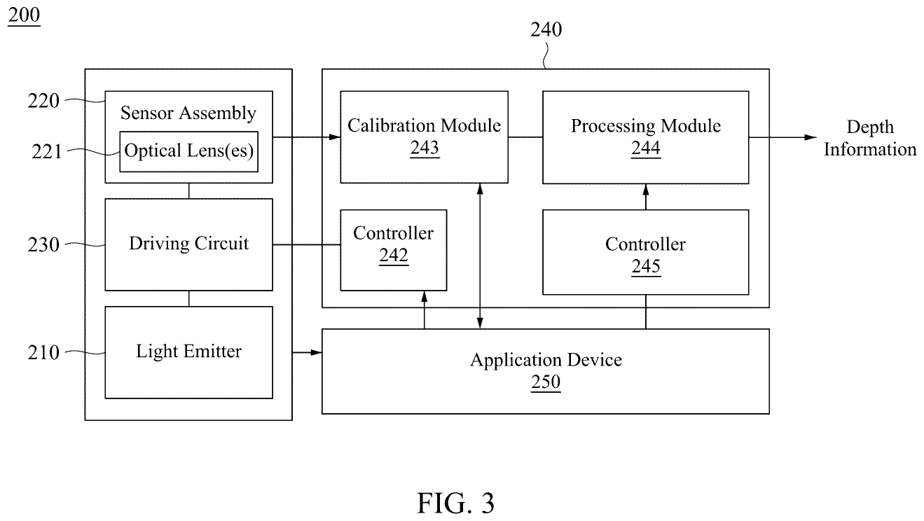

FIG. 3 is a schematic diagram showing a depth sensing system 200 in accordance with an embodiment of the present disclosure. The depth sensing system 200 includes a light emitter 210, a sensor assembly 220, a driving circuit 230, a depth decoding circuitry 240, and an application device 250. The difference between the depth sensing system 200 (shown in FIG. 3) and the depth sensing system 100 (shown in FIG. 2) is that the depth sensing system 200 does not include a neural network processing module in the depth decoding circuitry, but instead includes the application device 250. Other modules of the depth sensing system 200 and the functions thereof are similar to those described in the depth sensing system 100, and thus are not repeated herein.

In such embodiment, the application device 250 is configured to select the desired region of the target in the image by a user. For example, the user may frame or mark the portion of the image to be processed as the desired region through the application device 250. In the embodiment of the disclosure, the application device 250 may be a personal computer (PC), a server, a mobile device, an industrial controller such as a programmable logic controller (PLC) and a distributed control system (DCS), or the like.

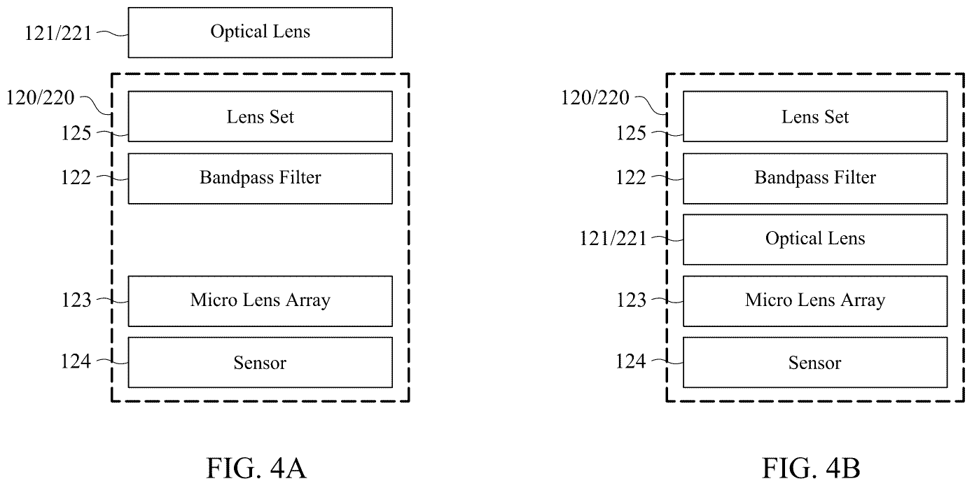

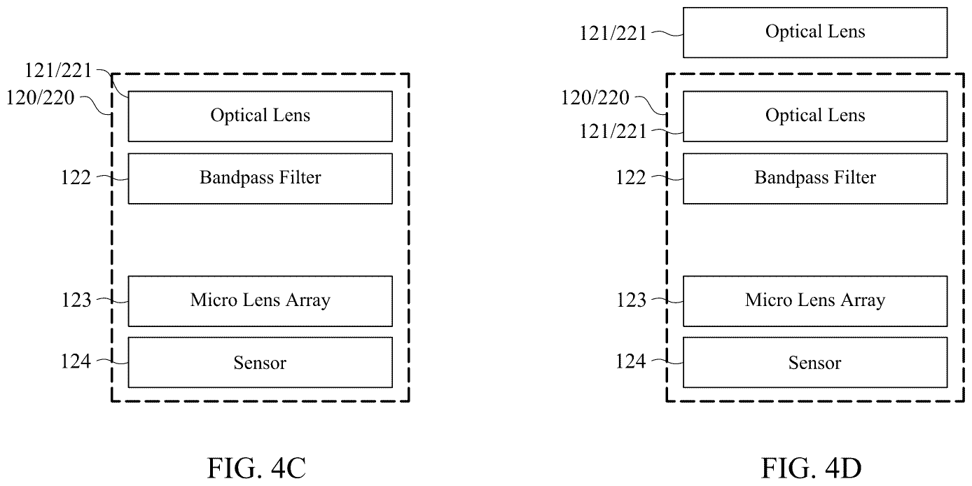

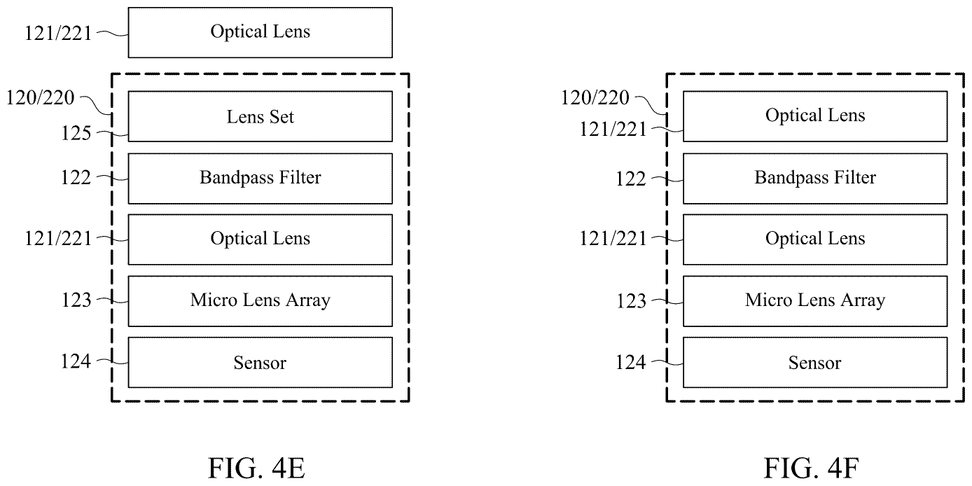

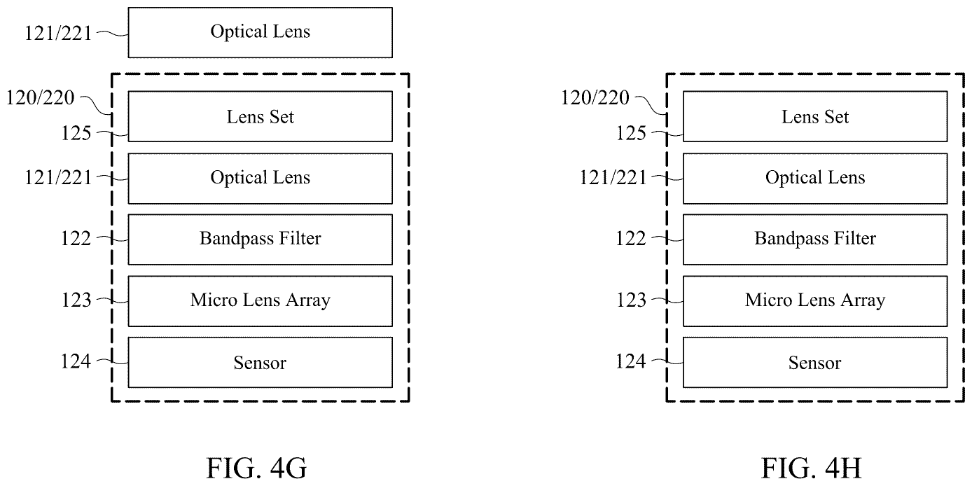

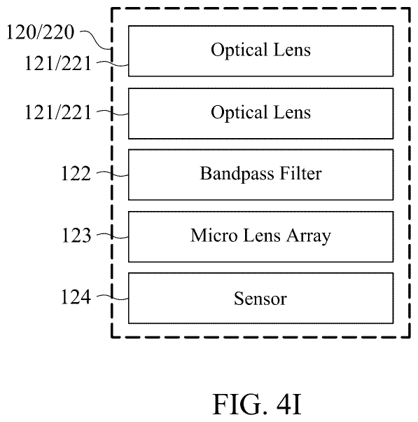

Referring to FIGS. 4A to 4I, FIGS. 4A to 4I are schematic diagrams showing various configurations of the sensor assembly 120/220 in accordance with some embodiments of the present disclosure.

In FIG. 4A, the optical lens 121/221 is disposed outside of the sensor assembly 120/220. In FIG. 4B, the optical lens 121/221 is disposed in the sensor assembly 120/220 and is disposed between the bandpass filter 122 and the micro lens array 123. In FIG. 4C, the optical lens 121/221 is disposed in the sensor assembly 120/220, and the sensor assembly 120/220 does not include the lens set 125. In FIG. 4D, the sensor assembly 120/220 is configured with two or more optical lenses 121/221, one of the optical lenses 121/221 is disposed in the sensor assembly 120/220, the other one of the optical lenses 121/221 is disposed outside of the sensor assembly 120/220, and the sensor assembly 120/220 does not include the lens set 125.

In FIG. 4E, the sensor assembly 120/220 is configured with two or more optical lenses 121/221, one of the optical lenses 121/221 is disposed in the sensor assembly 120/220 and is disposed between the bandpass filter 122 and the micro lens array 123, and the other one of the optical lenses 121/221 is disposed outside of the sensor assembly 120/220. In FIG. 4F, the sensor assembly 120/220 is configured with two optical lenses 121/221 that are respectively disposed on opposite sides of the bandpass filter 122.

In FIG. 4G, the sensor assembly 120/220 is configured with two or more optical lenses 121/221, one of the optical lenses 121/221 is disposed in the sensor assembly 120/220 and is disposed between the lens set 125 and the bandpass filter 122, and the other one of the optical lenses 121/221 is disposed outside of the sensor assembly 120/220. In FIG. 4H, the optical lens 121/221 is disposed in the sensor assembly 120/220, and is disposed between the lens set 125 and the bandpass filter 122. In FIG. 4I, the sensor assembly 120/220 is configured with two or more optical lenses 121/221, and these optical lenses 121/221 are all disposed in the sensor assembly 120/220.

It should be appreciated that the present disclosure is not limited to the above examples. For example, certain elements may be integrated into the same element or one or more elements may be added, removed, or altered as long as similar results/effects are achieved.

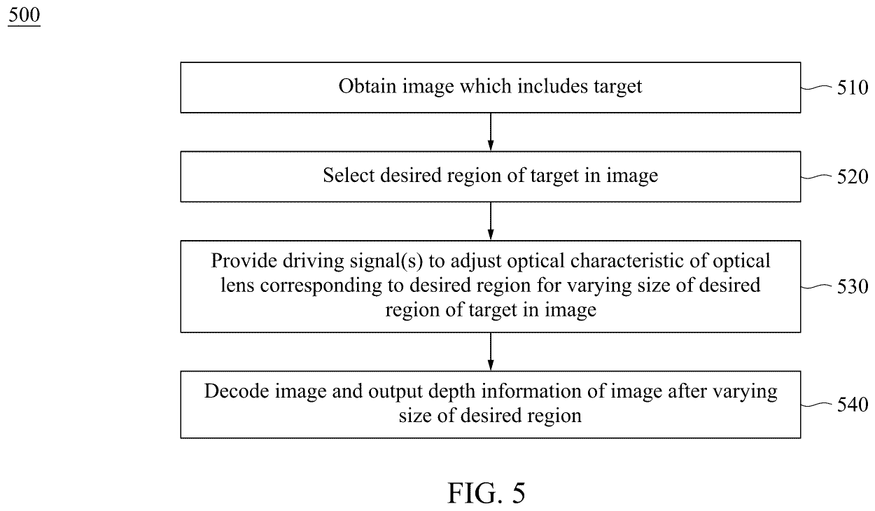

Referring to FIG. 5, FIG. 5 is a schematic diagram showing a depth sensing method 500 in accordance with an embodiment of the present disclosure. The depth sensing method 500 includes Steps 510 to 540, and these steps may be applied to the configuration shown in FIGS. 1 to 3 or another similar configuration. The configuration shown in FIG. 2 is taken as an example for the following description.

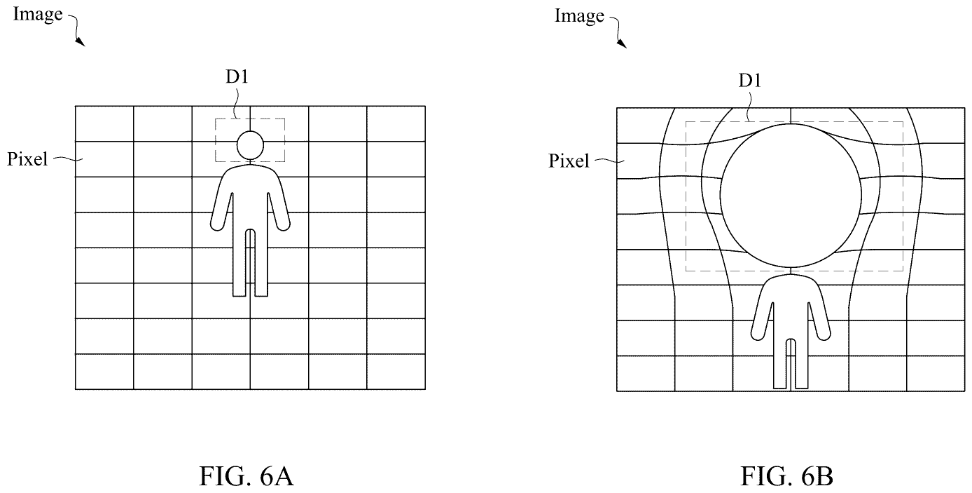

At Step 510, an image including the target is obtained first. The image may be generated by the sensor assembly 120. At Step 520, a desired region of the target in the image is selected. In the embodiment shown in FIG. 2, the desired region of the target in the image may be detected by the neural network processing module 141. In the embodiment shown in FIG. 3, the desired region of the target in the image may be marked or selected by the application device 250. As shown in FIG. 6A, the person is the target, and the desired region D1 is the face (or head) region framed by the dotted line in the image. The inadequate number of pixels in the desired region of the image results in too little information for analyzing the depth of the face (or head).

At Step 530, driving signal(s) are provided by the driving circuit 130 to adjust an optical characteristic of the optical lens (of the sensor assembly 120) corresponding to the desired region, thereby varying a size of the desired region of the target in the image. As shown in FIG. 6B, the desired region D1 of the target can be enlarged or reduced to an appropriate size, thereby increasing the number of pixels corresponding to the desired region of the target in the image and increasing the details and information available for decoding.

At Step 540, after varying the size of the desired region, the image is decoded by the depth decoding circuitry 140 to output the depth information of the image. In the embodiment of the disclosure, after varying the size of the desired region of the target in the image, the depth sensing method 500 further includes adjusting an internal camera parameter, a depth correction information, and a distortion correction information corresponding to the desired region in response to the variation in the size of the desired region. Next, the internal camera parameter, the depth correction information, and the distortion correction information corresponding to the desired region are transmitted to the depth decoding circuitry 140 for decoding the image. As a result, the depth decoding circuitry 140 can output the image having correct depth information and an enhanced spatial resolution.

The disclosure provides a depth sensing system and a depth sensing method thereof to enhance the spatial resolution of a desired region in an image by disposing an optical lens in a sensor assembly and dynamically adjusting the optical characteristic of the optical lens based on the desired region for varying a size of the desired region. In summary, the present disclosure does not linearly interpolate the digital image for magnification, but rather magnifies the desired region through the optical characteristics of the optical lens to increase the details and information available for decoding.

Although the description provided above is of various embodiments of the disclosure, this should not limit the scope of the disclosure. Those with ordinary skill in the art can make various modifications without departing from the spirit and scope of the disclosure. Therefore, the scope of protection of the present disclosure shall be determined by the following claims.

What is claimed is:

1. A depth sensing system, comprising:
a light emitter configured to emit a light source to a target;
a sensor assembly comprising at least one optical lens and configured to generate an image comprising the target based on the light source reflected from the target;
a driving circuit configured to provide one or more driving signals to adjust an optical characteristic of the at least one optical lens corresponding to a desired region of the target in the image for varying a size of the desired region of the target in the image; and
a depth decoding circuitry electrically connected to the light emitter, the sensor assembly, and the driving circuit, and configured to decode the image after varying the size of the desired region, and output depth information of the image.

2. The depth sensing system of claim 1, wherein the depth decoding circuitry comprises:
a neural network processing module configured to detect the desired region of the target in the image.

3. The depth sensing system of claim 2, wherein the depth decoding circuitry comprises:
a controller electrically connected between the driving circuit and the neural network processing module, and configured to control the driving circuit to provide the one or more driving signals corresponding to the desired region detected by the neural network processing module.

4. The depth sensing system of claim 1, wherein the depth decoding circuitry comprises:
a calibration module configured to adjust an internal camera parameter, depth correction information, and distortion correction information corresponding to the desired region in response to a variation in the size of the desired region.

5. The depth sensing system of claim 4, wherein the depth decoding circuitry comprises:
a processing module configured to decode the image based on the internal camera parameter, the depth correction information, and the distortion correction information corresponding to the desired region for outputting the depth information of the image.

6. The depth sensing system of claim 1, wherein the at least one optical lens is disposed in the sensor assembly.

7. The depth sensing system of claim 1, wherein the at least one optical lens is disposed outside of the sensor assembly.

8. The depth sensing system of claim 1, wherein the at least one optical lens is disposed inside and outside of the sensor assembly.

9. The depth sensing system of claim 1, wherein the at least one optical lens comprises one of a liquid crystal lens and a liquid lens.

10. The depth sensing system of claim 1, wherein the optical characteristic of the at least one optical lens comprises at least one of a curvature, a phase difference, and an applied voltage distribution.

11. The depth sensing system of claim 1, further comprising:
an application device configured to select the desired region of the target in the image by a user.

12. A depth sensing method, performed by a depth sensing system, wherein the depth sensing system comprises a sensor assembly comprising at least one optical lens, the depth sensing method comprising:
obtaining an image comprising a target;
selecting a desired region of the target in the image;
providing one or more driving signals to adjust an optical characteristic of the at least one optical lens corresponding to the desired region for varying a size of the desired region of the target in the image; and
decoding the image and outputting depth information of the image after varying the size of the desired region.

13. The depth sensing method of claim 12, wherein selecting the desired region of the target in the image further comprises:
inputting the image into a neural network processing module of the depth sensing system to detect the desired region of the target in the image.

14. The depth sensing method of claim 12, wherein selecting the desired region of the target in the image further comprises:
inputting the image into an application device to select the desired region of the target in the image by a user.

15. The depth sensing method of claim 12, wherein further comprises:
adjusting an internal camera parameter, depth correction information, and distortion correction information corresponding to the desired region in response to a variation in the size of the desired region after varying the size of the desired region of the target in the image.

16. The depth sensing method of claim 15, wherein further comprises:
decoding the image based on the internal camera parameter, the depth correction information, and the distortion correction information corresponding to the desired region to output the depth information of the image.

17. The depth sensing method of claim 12, wherein the optical characteristic of the at least one optical lens comprises a curvature, a phase difference, and an applied voltage distribution.

18. The depth sensing method of claim 12, wherein the at least one optical lens is disposed in the sensor assembly.

19. The depth sensing method of claim 12, wherein the at least one optical lens is disposed outside of the sensor assembly.

20. The depth sensing method of claim 12, wherein the at least one optical lens is disposed inside and outside of the sensor assembly.
